(19) United States
(12) Patent Application Publication
(10) Pub. No.: US 2019/0026207 A1
(43) Pub. Date: Jan. 24, 2019

(54) METRIC TRANSMISSION

(71) Applicant: VMWARE, INC., Palo Alto, CA (US)

(72) Inventor: RAJEEV BAKSHI, Bangalore (IN)

(21) Appl. No.: 15/695,032

(22) Filed: Sep. 5, 2017

(30) Foreign Application Priority Data
Jul. 19, 2017 (IN) 201741025680

(51) Int. Cl. G06F 11/30; H04L 29/08; H04L 12/24

(52) U.S. Cl. CPC G06F 11/3006; G06F 11/301; H04L 69/329; H04L 67/02; G06F 2201/81; G06F 2201/815; H04L 41/5096

(57) ABSTRACT

Metric transmission can include receiving, from a metrics source, a set of values for each of a plurality of metrics, determining a location in a polyhedral space that corresponds to the set of values, and communicating the determined location to a management server.

### RELATED APPLICATIONS

Benefit is claimed under 35 U.S.C. 119(a)-(d) to Foreign Application Serial No. 201741025680 filed in India entitled “METRIC TRANSMISSION”, on Jul. 19, 2017, by VMware, Inc., which is herein incorporated in its entirety by reference for all purposes

### BACKGROUND

Metrics can be used to monitor changes in data over time. System metrics, for instance, can include central processing unit (CPU) usage and/or memory usage, among others. Application metrics can include stock prices and/or number(s) of nodes in a social graph, for example. In a metric collection system, a set of endpoints may periodically send metrics to one or more consumers of metrics.

However, the communication of metrics means the communication of data. As the amount and/or frequency of metrics being communicated rises, system resources may be strained. Because metrics are numbers and can behave like raw data, common compression libraries may be ineffective at reducing the amount of communicated data.

### BRIEF DESCRIPTION OF THE DRAWINGS

FIG. 1 is a diagram of an example of an infrastructure metric transmission according to the present disclosure.

FIG. 2 is a diagram of a system for metric transmission according to the present disclosure.

FIG. 3 is a diagram of an example system structure implementing metric transmission according to the present disclosure.

FIG. 4 illustrates a diagram of a non-transitory machine-readable medium for metric transmission according to the present disclosure.

### DETAILED DESCRIPTION

A metrics source, as used herein, refers to a source of metrics. In general, a metrics source can refer to any entity capable of generating metrics and/or monitoring data. For instance, a metrics source can be a server (e.g., a physical server), a virtual computing instance (VCI), an application, a host, a network device, a desktop computing device, an event channel, a log aggregator, a log file, etc. Herein, a metrics source may be alternatively referred to as an “endpoint.” A management server and/or an operations management server (referred to herein as “management server”) can configure and/or monitor metrics sources, and can receive metrics from metrics sources. Metrics can be collected from objects in an environment. Each metric can be an observation or value. Metrics can include raw metrics. Metrics can include self-monitoring metrics. Metrics can include capacity metrics, badge metrics, and/or metrics to monitor the health of a computing system.

The term VCI covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in a software defined data center. In such a system, information can be propagated from an end user to at least one of the VCIs in the system, between VCIs in the system, and/or between at least one of the VCIs in the system and a management server. In some embodiments, the management server can be provided as a VCI. Software defined data centers are dynamic in nature. For example, VCIs and/or various application services, may be created, used, moved, or destroyed within the software defined data center. When VCIs are created, various processes and/or services start running and consuming resources. As used herein, “resources” are physical or virtual components that have a finite availability within a computer or software defined data center. For example, resources include processing resources, memory resources, electrical power, and/or input/output resources.

As previously discussed, metric transmission under previous approaches can include a large amount of data. If N metrics m₀, m₁ . . . , m_{N-1} are transmitted periodically at a frequency F from endpoints E which are acting as transmitters to a set of consumers over a channel (e.g., RabbitMQ, eMQTT, etc.), the amount of data D transferred over the channel can be determined by D=N*E*B*1/F bytes per second (where B is number of bytes used to represent one metric). For example, assume that a set of 200,000 endpoints each sends 20 metrics every 10 seconds. 20*200,000*( 1/10)=400,000=4*10⁵ metrics per second. If 4 bytes are used to represent each metric, the amount of data transmitted can be 4*10⁵*4 bytes/sec=16*10⁵/1024/1024=1.526 MB/s. If 8 bytes are used to represent each metric, the amount of data transmitted doubles to 3.05 MB/s.

Embodiments of the present disclosure can greatly reduce the amount of data in metric transmissions. In some embodiments, for instance, a set (e.g., a plurality) of metrics can be represented by a single metric (sometimes referred to herein as an “ubermetric”). As a result, the use of system resources for metric transmission can be reduced. Further, because the consumers of metrics can receive fewer numbers of metrics, the number of network connections can be reduced. Thus, embodiments herein can directly improve the functioning of computing devices involved in the transmission and/or reception of metrics. Moreover, the reduction in the amount of data transmitted yields additional tangible benefits. For instance, slow network speeds, such as in SaS environments, may have crippled previous approaches to metric transmission but can be accommodated by the use of embodiments herein. Costly resources can be directed to other tasks instead of metric transmission.

In brief, embodiments of the present disclosure can provide these benefits by taking a plurality of linear (e.g., one-dimensional) numerical metrics and representing them by a single numerical metric (e.g., vector) in a multidimensional space. For example, a set of 100 metrics can be formulated into, and represented by, a single 100-dimension ubermetric. The ubermetric comprises a much smaller amount of data than do the 100 metrics and can thus ease burdens on system resources. For instance, embodiments herein can reduce processing and/or consumed bandwidth, and can be used for lossless compression. Once received, the ubermetric can be de-formulated and converted back into the set of metrics.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

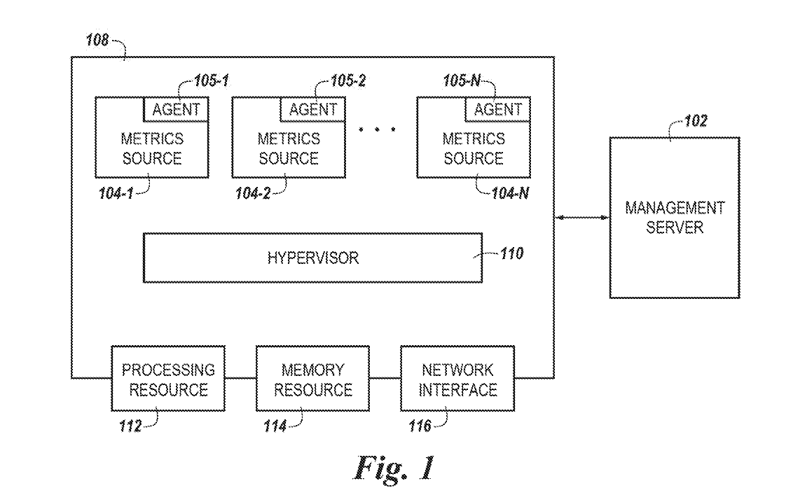

The figures herein follow a numbering convention in which the first digit or digits correspond to the drawing figure number and the remaining digits identify an element or component in the drawing. Similar elements or components between different figures may be identified by the use of similar digits. For example, 112 may reference element “12” in FIG. 1, and a similar element may be referenced as 312 in FIG. 3. A group or plurality of similar elements or components may generally be referred to herein with a single element number. For example a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

FIG. 1 is a diagram of an example of an infrastructure metric transmission according to the present disclosure. For example, FIG. 1 can be a diagram of a host 108 for metric transmission according to the present disclosure. The host 108 can include processing resources 112 (e.g., a number of processors), memory resources 114, and/or a network interface 116. Memory resources 114 can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media. For example, the memory resources 114 may comprise primary and/or secondary storage.

The host 108 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 108 can incorporate a hypervisor 110 that can execute a number of VCIs 104-1, 104-2, . . . , 104-N that can each provide the functionality of a metrics source. As such, the VCIs may be referred to herein as “metrics sources.” The metrics sources 104-1, 104-2, . . . , 104-N are referred to generally herein as “metrics sources 104.” The metrics sources 104 can be provisioned with processing resources 112 and/or memory resources 114 and can communicate via the network interface 116. The processing resources 112 and the memory resources 114 provisioned to the servers 104 can be local and/or remote to the host 108. For example, in a software defined data center, the metrics sources 104 can be provisioned with resources that are generally available to the software defined data center and are not tied to any particular hardware device. By way of example, the memory resources 114 can include volatile and/or non-volatile memory available to the metrics sources 104. The metrics sources 104 can be moved to different hosts (not specifically illustrated), such that different hypervisors manage the metrics sources 104. In some embodiments, a metrics source among the number of metrics sources can be a master metrics source. For example, metrics sources 104-1 can be a master metrics sources, and metrics sources 104-2, . . . , 104-N can be slave metrics sources. In some embodiments, each metrics sources 104 can include a respective agent 105-1, 105-2, . . . , 105-N (referred to generally herein as agents 105) deployed thereon.

In some embodiments, each the metrics sources 104 can provide a same functionality. In some embodiments, one or more of the metrics sources 104 can provide a different functionality than another of the one or more metrics sources 104. In some embodiments, one or more of the metrics sources 104 are system metrics sources. In some embodiments, one or more of the metrics sources 104 are application metrics sources. In a number of embodiments, one or more of the metrics sources 104 can be servers, such as files servers, print servers, communication servers (such as email, remote access, firewall, etc.), application servers, database servers, web servers, and others. Embodiments herein are not intended to limit the metrics sources 104 to a particular type and/or functionality.

The metrics sources 104 can each record and/or determine metrics. The metrics can be recorded in real time, for instance. In some embodiments, the metrics can track aspects of a number of applications and/or programs. In some embodiments, the logs can track physical and/or virtual hardware usage. In some embodiments, metrics are numbers.

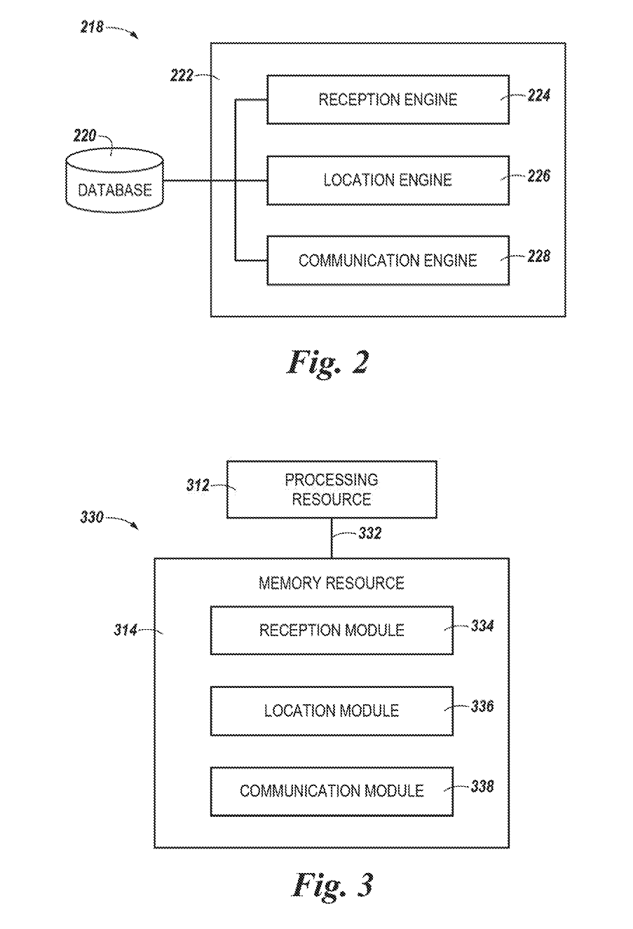

FIG. 2 is a diagram of a system for metric transmission according to the present disclosure. The system shown in FIG. 2 can be implemented in an agent, for instance, such as one or more of the agents 105, previously discussed, though embodiments of the present disclosure are not so limited.

The system 218 can include a database 220, a subsystem 222, and/or a number of engines, for example a reception engine 224, a location engine 226, and/or a communication engine 228, and can be in communication with the database 220 via a communication link. The system 218 can include additional or fewer engines than illustrated to perform the various functions described herein. The system 218 can represent program instructions and/or hardware of a machine (e.g., machine 330 as referenced in FIG. 3, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines (e.g., 224, 226, 228) can include a combination of hardware and program instructions that are configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the reception engine 224 can include a combination of hardware and program instructions that can be configured to receive, from a metrics source, a set of values for each of a plurality of metrics. For clarity, the following list of symbols is provided:
[symbol] : set of real numbers
[symbol] : set of integers
[symbol] ^{M}: real coordinate space of M dimensions (e.g., M-dimensional vector of real numbers)
[symbol] ^{M}: integer coordinate space of M dimensions (e.g., M-dimensional vector of integers
N: number (quantity) of metrics sent from each endpoint
E: total quantity of endpoints
F: frequency at which metrics are sent
B: total bytes used to represent one metric (e.g., according to previous approaches)
b: total bytes used to represent one ubermetric according to the present disclosure
M: quantity of total input metrics (M=N*E)
m^{j}: set of input metrics at time interval j (e.g., includes m₀^{j}, m₁^{j}, . . . m_{M-1}^{j})
mᵢ^{j}: ith metric in jth interval
V: polyhedron which bounds the range of metrics
U: polyhedron which bounds the active movement of metrics from a first interval to a second interval
l: number produced by formulation of M metrics (e.g., ubermetric of the M metrics)
Dᵢ: ith dimension in the representation (corresponds to ith input metric)
   |Di|: size of the ith dimension in the polyhedron U
d^{(dim)}: d raised to the power of dim
O^{j}: origin of centroid of U at the interval j. (e.g., includes o₀^{j}, o₁₀^{j}, . . . o_{M-1}^{j})
oᵢ^{j}: origin point for the ith dimension at interval j
   The M metrics received (e.g., at the agent) transmitted at the interval i can be considered as a point vⁱ in the space [symbol] ^{M}. Though the total range of vⁱ may be relatively large, the movement from vⁱ to vⁱ⁺¹ can be relatively short. Stated differently, metrics may change relatively continuously and/or not randomly. It is noted that [symbol] ^{M} can be translated to [symbol] ^{M} with scalar multiplication if such granularity is desired. Over a period (e.g., a day) where a number of metrics transmissions are made to the management server, the different points V can span a polyhedron V∈ [symbol] ^{M}. Because the points vⁱ to vⁱ⁺¹ are relatively near to each other, U∈ [symbol] ^{M} (where volume of U is much less than volume of V) can be utilized instead of V∈ [symbol] ^{M}, in some embodiments.

U can be divided into unit size polyhedrons and given a numbering L. Stated differently, the polyhedron can be divided into a plurality of polyhedral unit-spaces. The term “unit size” can mean that a size of each of the plurality of unit-spaces of the multidimensional polyhedron is a first unit in a first dimension, a second unit in a second dimension, and a third unit in a third dimension, etc. In some embodiments, units for metrics may be the same. In some embodiments, units for metrics may be different. In some embodiments, units may be real numbers. In some embodiments, units may be integers. The unit-spaces can each be given an identifier (e.g., a number), and the set of those numbers can be referred to as L. Thus, embodiments herein can yield a bijection between the set of points∈U and the set of points∈L. As discussed further below, the inverse of this bijection can be utilized in de-formulation. In the numbering L, an individual unit-space can be identified by number, represented, for instance, by l.

In some embodiments, the location engine 226 can include a combination of hardware and program instructions that can be configured to determine a location in a polyhedral space that corresponds to the set of values. The set of M metrics can be formulated to a single number (e.g., an ubermetric) by the function ϕ: [symbol] ^{M} [symbol] [symbol] . The number l can be determined by the following function ϕ:

$$l = φ ( {m}^{j} ) = {\sum }_{dim = 0}^{M - 1} ( ( {m}_{dim}^{j} - {o}_{dim}^{j} ) * {\prod }_{i = 0}^{dim - 1} \vert {D}_{i} \vert )$$

U can shift at each interval and thus the corresponding origin of U can shift accordingly. At interval j, the moving origin for the dimension dim can be denoted by o_{dim}^{j}. The moving origin O^{j} can be determined from a previous set of input metrics (e.g., a most recently received set of metrics) M^{j-1}. O^{j}=centroid (U^{j-1}) and can be updated at each interval similarly based on the previous set of input metrics. O⁰ can be seeded with initial values for the input metrics M⁰. Time complexity for the above formulation can be O(M) on a single threaded process because, for instance, the summation is over M terms, |Dᵢ| can be optimized beforehand, and Πᵢ₌₀^{dim-1}|Dᵢ| can be fetched in O(1). Because the M terms of Σ_{dim=0}^{M-1} are independent, they can be executed in parallel, in some embodiments. With t threads in execution, computation can be done in O(M/t) and, if t is less than or equal to M, it can be done in O(1). The constraints in the O(1) can be dependent upon efficiency of number arithmetic. Depending on the ability of a particular computing device to perform the arithmetic, ubermetrics can be determined from different sized metrics. For example, a smaller set of metrics may be converted to an ubermetric on a platform with reduced capability. In some embodiments, no extra space is needed for the determination apart from |Di| (e.g., being M terms in total); thus, the space complexity can be O(1).

The magnitude of the ubermetric l can grow exponentially in |Di| (e.g., as the number of input metrics increases). For instance, if |Di| are all the same, and if d and oᵢ are 0, then l=Σ_{dim=0}^{M-1}(m_{dim}*d^{(dim)}). However, the number of decimal digits for the ubermetric l can grow much slower with an increase in the number of input metrics. For instance, according to l=Σ_{dim=0}^{M-1}(m_{dim}*d^{(dim)}), the number of decimal digits are log₁₀ l. For log₁₀ l to increase by 1, l needs to increase by 10 times.

In some embodiments, the communication engine 228 can include a combination of hardware and program instructions that can be configured to communicate the determined location to a management server. Stated differently, the formulated number l can be transferred over the channel to the receiving entity (e.g., the management server). In some embodiments, the receiving entity can de-formulate the number l (e.g., convert l back to the set of M metrics). In some embodiments, the set of M metrics can be converted back to the same order. In some embodiments the order can be an order in which the metrics were received. The conversion can be carried out by function ϕ: [symbol] [symbol] [symbol] ^{M}.

$${m}_{i}^{j} = ϕ ( l ) = ⌊ \frac{{t}_{i - 1}^{j} - ( {Π}_{k = 0}^{i} \vert Di \vert ) {s}_{i - 1}^{j}}{{Π}_{q = 0}^{i - 1} \vert Di \vert} ⌋ = ⌊ \frac{{t}_{i - 1}^{j} - ( {ℊ}_{i}^{j} ) {s}_{i - 1}^{j}}{( {h}_{i}^{j} )} ⌋$$

These terms can be determined iteratively. It is noted that all terms can be with respect to a same given interval j and 0≤i≤M where i=M is an initial condition. The initial condition can be hypothetical and can be kept to streamline computations. Term i can be determined after term i+1 in this order of determination. Table 1 illustrates a plurality of terms, their initial definitions, and their iterative definitions in accordance with embodiments of the present disclosure.

TABLE 1

| Term | Initial definitions | Iterative definitions |
|---|---|---|
| t | t_{M} = q_{M} = l | tₛ = qᵢ₊₁ |
| s | s_{M} = 0 | sᵢ = mᵢ₊₁ |
| g | ${g}_{M} = {\prod }_{k = 0}^{M} \vert {D}_{i} \vert$ | ${g}_{i} = \frac{{g}_{i + 1}}{\vert {D}_{i + 1} \vert}$ |
| h | ${h}_{M} = {\prod }_{k = 0}^{M - 1} \vert {D}_{i} \vert$ | ${h}_{i} = \frac{{h}_{i}}{\vert {D}_{i} \vert}$ |
| q | q_{M} = l | qᵢ = tᵢ − gᵢ * sᵢ |
| m | m_{M} = 0 | ${m}_{i} = ⌊ \frac{{q}_{i}}{{h}_{i}} ⌋$ |
| D | \|D_{M}\| = 1 | \|Dᵢ\| |

Table 2 illustrates an example of de-formulation of an ubermetric comprised of 3 metrics (M=3). m₃ can be initially defined, and then m₂, m₁, and m₀ can be determined in that order.

TABLE 2

| Index: i | 3 | 2 | 1 | 0 |
|---|---|---|---|---|
| tᵢ | t | = q₃ = i | = q₂ = i | $= {q}_{1} = i - {D}_{0} {D}_{1} ⌊ \frac{i - 0}{{D}_{0} {D}_{1}} ⌋$ |
| gᵢ | D₀D₁D₂D₃ | D₀D₁D₂ | D₀D₁ | D₀ |
| [symbol] | o | = m₃ = 0 | $= {m}_{2} = ⌊ \frac{i - 0}{{D}_{0} {D}_{1}} ⌋$ | $= {m}_{1} = ⌊ \frac{i - {D}_{0} {D}_{1} ⌊ \frac{i - 0}{{D}_{0} {D}_{1}} ⌋}{{D}_{0}} ⌋$ |
| hᵢ | D₀D₁D₂ | D₀D₁ | D₀ | 1 |
| [symbol] | i | = t₂ − g₂s₂ = i − 0 | $= {i}_{1} - {g}_{1} {s}_{1} = i - {D}_{0} {D}_{1} ⌊ \frac{i - 0}{{D}_{0} {D}_{1}} ⌋$ | $= {i}_{0} - {g}_{0} {s}_{0} = i - {D}_{0} {D}_{1} ⌊ \frac{i - 0}{{D}_{0} {D}_{1}} ⌋ - {D}_{0} ⌊ \frac{i - {D}_{0} {D}_{1} ⌊ \frac{i - 0}{{D}_{0} {D}_{1}} ⌋}{{D}_{0}} ⌋$ |
| mᵢ | 0 | $= ⌊ \frac{{q}_{2}}{{h}_{2}} ⌋ = ⌊ \frac{i - 0}{{D}_{0} {D}_{1}} ⌋$ | $= ⌊ \frac{{q}_{1}}{{h}_{1}} ⌋ = ⌊ \frac{i - {D}_{0} {D}_{1} ⌊ \frac{i - 0}{{D}_{0} {D}_{1}} ⌋}{{D}_{0}} ⌋$ | $= ⌊ \frac{{q}_{0}}{{h}_{0}} ⌋ = ⌊ \frac{i - {D}_{0} {D}_{1} ⌊ \frac{i - 0}{{D}_{0} {D}_{1}} ⌋ - {D}_{0} ⌊ \frac{i - {D}_{0} {D}_{1} ⌊ \frac{i - 0}{{D}_{0} {D}_{1}} ⌋}{{D}_{0}} ⌋}{1} ⌋$ |

[symbol]

indicates data missing or illegible when filed

As Table 2 suggests, there can be common overlapping subproblems across the determinations of mᵢ. In a given interval, a subproblem can be determined once, for instance, preserved as memo, and fetched upon a subsequent reference to the same sub-problem.

FIG. 3 is a diagram of an example system structure implementing metric transmission according to the present disclosure. For example, FIG. 3 can be a diagram of a machine for metric transmission according to the present disclosure. The machine 330 can utilize software, hardware, firmware, and/or logic to perform a number of functions. The machine 330 can be a combination of hardware and program instructions configured to perform a number of functions (e.g., actions). The hardware, for example, can include a number of processing resources 312 and a number of memory resources 314, such as a machine-readable medium (MRM) or other memory resources 314. The memory resources 314 can be internal and/or external to the machine 330 (e.g., the machine 330 can include internal memory resources and have access to external memory resources). The program instructions (e.g., machine-readable instructions (MRI)) can include instructions stored on the MRM to implement a particular function. The set of MRI can be executable by one or more of the processing resources 312. The memory resources 314 can be coupled to the machine 330 in a wired and/or wireless manner. For example, the memory resources 314 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

The memory resources 314 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 312 can be coupled to the memory resources 314 via a communication path 332. The communication path 332 can be local or remote to the machine 330. Examples of a local communication path 332 can include an electronic bus internal to a machine, where the memory resources 314 are in communication with the processing resources 312 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 332 can be such that the memory resources 314 are remote from the processing resources 312, such as in a network connection between the memory resources 314 and the processing resources 312. That is, the communication path 332 can be a network connection. Examples of such a network connection can include a local area network (LAN), wide area network (WAN), personal area network (PAN), and the Internet, among others.

As shown in FIG. 3, the MRI stored in the memory resources 314 can be segmented into a number of modules 334, 336, 338 that when executed by the processing resources 312 can perform a number of functions. As used herein a module includes a set of instructions included to perform a particular task or action. The number of modules 334, 336, 338 can be sub-modules of other modules. For example, the communication module 338 can be a sub-module of the reception module 336 and/or can be contained within a single module. Furthermore, the number of modules 334, 336, 338 can comprise individual modules separate and distinct from one another. Examples are not limited to the specific modules 334, 336, 338 illustrated in FIG. 3.

Each of the number of modules 334, 336, 338 can include program instructions and/or a combination of hardware and program instructions that, when executed by a processing resource 312, can function as a corresponding engine as described with respect to FIG. 2. For example, the reception module 334 can include program instructions and/or a combination of hardware and program instructions that, when executed by a processing resource 312, can function as the reception engine 224, the location module 336 can include program instructions and/or a combination of hardware and program instructions that, when executed by a processing resource 312, can function as the location engine 226, and/or the communication module 338 can include program instructions and/or a combination of hardware and program instructions that, when executed by a processing resource 312, can function as the communication engine 228.

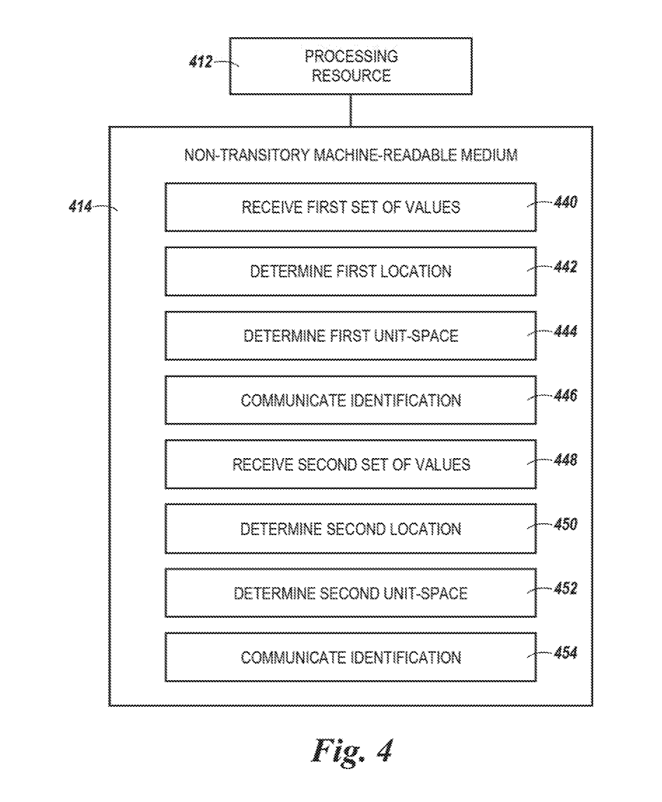

FIG. 4 illustrates a diagram of a non-transitory machine-readable medium for metric transmission according to the present disclosure. The medium 414 can be part of a machine that includes a processing resource 412. The processing resource 412 can be configured to execute instructions stored on the non-transitory machine readable medium 414. For example, the non-transitory machine readable medium 414 can be any type of volatile or non-volatile memory or storage, such as random access memory (RAM), flash memory, read-only memory (ROM), storage volumes, a hard disk, or a combination thereof. When executed, the instructions can cause the processing resource 412 to transmit one or more metrics in accordance with the present disclosure.

The medium 414 can store instructions 440 executable by the processing resource 412 to receive, from a metrics source, a first set of values for each of a plurality of metrics. The medium 414 can store instructions 442 executable by the processing resource 412 to determine a first point corresponding to the first set of values in a polyhedral space, wherein the polyhedral space is sectioned into a plurality of unit-spaces. The medium 414 can store instructions 444 executable by the processing resource 412 to determine a first unit-space that corresponds to the first point. The medium 414 can store instructions 446 executable by the processing resource 412 to communicate an identification of the first unit-space (e.g., a number corresponding to the first unit-space) to a management server. The medium 414 can store instructions 448 executable by the processing resource 412 to receive, from the metrics source, a second set of values for each of the plurality of metrics. The medium 414 can store instructions 450 executable by the processing resource 412 to determine a second location corresponding to the second set of values in the polyhedral space. The medium 414 can store instructions 452 executable by the processing resource 412 to determine a second unit-space that corresponds to the second point. The medium 414 can store instructions 454 executable by the processing resource 412 to communicate an identification of the second unit-space (e.g., a number corresponding to the second unit-space) to the management server.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for metric transmission, comprising:
receiving, from a metrics source, a set of values for each of a plurality of metrics;
determining a location in a polyhedral space that corresponds to the set of values; and
communicating the determined location to a management server.

2. The method of claim 1, wherein the method includes communicating the determined location as a number.

3. The method of claim 1, wherein the method includes communicating the determined location as one of a plurality of polyhedral unit-spaces into which the polyhedral space is divided.

4. The method of claim 1, wherein the method includes communicating a number corresponding to a particular one of a plurality of polyhedral unit-spaces into which the polyhedral space is divided.

5. The method of claim 1, wherein the method includes receiving the set of values for each of a plurality of computing system metrics.

6. The method of claim 1, wherein the method includes receiving the set of values for each of a plurality of application metrics.

7. The method of claim 1, wherein the method includes:
receiving another set of values for each of the plurality of metrics after receiving the set of values;
determining another location in the polyhedral space that corresponds to the other set of values; and
communicating the other determined location to the management server.

8. The method of claim 1, wherein the method includes determining a quantity of dimensions of the polyhedral space corresponding to a quantity of the plurality of metrics.

9. The method of claim 1, wherein the method includes converting, by the management server, the communicated determined location to the set of values.

10. The method of claim 9, wherein the method includes converting the determined location to the set of values in a same order as an order in which the values were received.

11. A non-transitory machine-readable medium having instructions stored thereon executable by a processor to:
receive, from a metrics source, a first set of values for each of a plurality of metrics;
determine a first location corresponding to the first set of values in a polyhedral space, wherein the polyhedral space is sectioned into a plurality of unit-spaces, and wherein the first location corresponds to a first unit-space of the plurality of unit-spaces;
communicate an identification of the first unit-space to a management server;
receive, from the metrics source, a second set of values for each of the plurality of metrics;
determine a second point corresponding to the second set of values in the polyhedral space, wherein the second point corresponds to a second unit-space of the plurality of unit-spaces; and
communicate an identification of the second unit-space to the management server.

12. The medium of claim 11, including instructions to determine the second set of values after the first set of values.

13. The medium of claim 11, including instructions to determine the first set of values and the second set of values according to a particular interval.

14. A system, comprising:
a processor; and
a memory having instructions stored thereon which, when executed by the processor, cause the processor to:
receive a first set of values, the first set including a respective value for each of a first metric, a second metric, and a third metric at a first time instance;
determine a first location corresponding to the first set of values in a polyhedral space, wherein the polyhedral space is sectioned into a plurality of unit-spaces;
determine a first unit-space that corresponds to the first location;
communicate a number corresponding to the first unit-space to a management server;
receive, from the metrics source, a second set of values, the second set including a respective value for each of the first metric, the second metric, and the third metric at a second time instance;
determine a second location corresponding to the second set of values in the polyhedral space;
determine a second unit-space that corresponds to the second location; and
communicate a number corresponding to the second unit-space to the management server.

15. The system of claim 14, including instructions to determine that a first dimension of the polyhedral space corresponds to the first metric, a second dimension of the polyhedral space corresponds to the second metric, and a third dimension of the polyhedral space corresponds to the third metric.

16. The system of claim 14, wherein:
the values for the first metric are described by a first unit;
the values for the second metric are described by a second unit; and
the values for the third metric are described by a third unit.

17. The system of claim 16, wherein a size of each of the plurality of unit-spaces is the first unit in the first dimension, the second unit in the second dimension, and the third unit in the third dimension.

18. The system of claim 14, wherein the first metric, the second metric, and the third metric are computing system metrics.

19. The system of claim 14, wherein the first metric, the second metric, and the third metric are application metrics.

20. The system of claim 14, including instructions to convert, by the management server, the number corresponding to the first unit-space and the number corresponding to the second unit space to the first set of values and the second set of values, respectively.
